(19) United States
(12) Patent Application Publication
(10) Pub. No.: US 2023/0286531 A1
(43) Pub. Date: Sep. 14, 2023

(54) AUTONOMOUS VEHICLE SYSTEM TEST MODULE

(71) Applicant: Argo AI, LLC, Pittsburgh, PA (US)

(72) Inventors: Michel H.J. LAVERNE, Pittsburgh, PA (US); Quintessa GUENGERICH, Pittsburgh, PA (US); Ilan BIALA, Pittsburgh, PA (US)

(73) Assignee: Argo AI, LLC, Pittsburgh, PA (US)

(21) Appl. No.: 17/690,661

(22) Filed: Mar. 9, 2022

(51) Int. Cl. B60W 60/00; B60W 30/18; B60W 50/10; H04L 12/40

(52) U.S. Cl. CPC B60W 60/001; B60W 30/18109; B60W 50/10; H04L 12/40; B60W 2540/18; B60W 2540/30; H04L 2012/40215

(57) ABSTRACT

A test module is provided with a housing for mounting within a cabin of an autonomous vehicle (AV). At least two user input devices are supported by the housing. A controller is disposed within the housing and programmed to: generate a first request to control an AV system of the AV based on manual activation of one of the at least two user input devices, and generate a second request to control the AV system based on manual activation of the other of the at least two user input devices. At least one transceiver provides the first request to the AV on a first communication interface and provides the second request to the AV system on a second communication interface.

### TECHNICAL FIELD

One or more embodiments relate to a test module for manually controlling an autonomous vehicle system and a method for testing the test module.

### BACKGROUND

An autonomous vehicle may include a system to monitor its external environment to detect the presence of specific objects, e.g., traffic lights, street signs, and other vehicles. The system may include sensors or cameras for detecting the objects. The system may also use one or more strategies to determine the location of the objects based on data from the sensors or cameras. The system may also determine the three-dimensional (3D) location of the specific objects relative to the vehicle. The vehicle may control one or more other vehicle systems, e.g., braking and steering, based on these 3D locations.

During development, a vehicle system may be tested in various configurations, e.g., on a bench and in-vehicle. A test vehicle may include provisions to rapidly decelerate or shut down the vehicle in the event the system under test does not function properly. For example, a test vehicle may include an emergency stop button that is coupled to the vehicle’s propulsion system and/or braking system and mounted within a vehicle cabin that allows an occupant of the vehicle to shut down the vehicle. Such an emergency stop of an autonomous vehicle may present challenges, e.g., if an occupant of the driver is not ready to take control of the vehicle.

### SUMMARY

In one embodiment, a test module is provided with a housing for mounting within a cabin of an autonomous vehicle (AV). At least two user input devices are supported by the housing. A controller is disposed within the housing and programmed to: generate a first request to control an AV system of the AV based on manual activation of one of the at least two user input devices, and generate a second request to control the AV system based on manual activation of the other of the at least two user input devices. At least one transceiver provides the first request to the AV on a first communication interface and provides the second request to the AV system on a second communication interface.

In another embodiment, a method is provided for testing a test module for an autonomous vehicle (AV) system. A first request to control the AV system is generated based on manual activation of a first user input device of the test module. A second request to control the AV system is generated based on manual activation of a second user input device of the test module. The first request is transmitted to an AV on a first communication interface. The second request is transmitted to the AV system on a second communication interface.

In yet another embodiment, a non-transitory computer-readable medium is provided having instructions stored thereon that, when executed by at least one computing device, cause the at least one computing device to perform operations comprising: generating a first request to control an autonomous vehicle (AV) system based on manual activation of a first user input device; generating a second request to control the AV system based on manual activation of a second user input device; transmitting the first request to an AV on a first communication interface; transmitting the second request to the AV system on a second communication interface; monitoring a first voltage across a first switch coupled to the first user input device; and controlling a first light emitting device mounted proximate to the first user input device to blink in response to the first voltage indicating a first switch fault.

### BRIEF DESCRIPTION OF THE DRAWINGS

FIG. 1 illustrates an exemplary autonomous vehicle system with a test module, in accordance with aspects of the disclosure.

FIG. 2 illustrates an exemplary architecture of the autonomous vehicle system of FIG. 1.

FIG. 3 illustrates an exemplary architecture of the test module of FIG. 1.

FIG. 4 is a flow chart illustrating a method for testing the test module.

FIG. 5 is a flow chart illustrating a button test step of the method of FIG. 4.

FIG. 6 is a detailed schematic diagram of an example computer system for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

As required, detailed embodiments are disclosed herein; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

With reference to FIG. 1, a test module for testing an autonomous vehicle (AV) system is illustrated in accordance with one or more embodiments and generally referenced by numeral 100. The test module 100 is disposed within an AV 102 and communicates with an AV system 104. The AV system 104 includes a controller 106 and a sensor system 108 that includes one or more cameras and sensors for monitoring an environment external to the AV 102. The AV system 104 also includes a communication interface 110, such as a transceiver, for communicating with other systems and devices, e.g., the test module 100. The AV system 104 also includes a user interface 112 for communicating with a user. The test module 100 includes a series of buttons 114 that allow a user to manually control features of the AV system 104 during testing. The test module 100 also tests itself prior to in-vehicle testing.

The sensor system 108 includes multiple cameras to capture images of the external environment about the AV 102. The cameras may include visible spectrum cameras, infrared cameras, etc. The sensor system 108 also includes a ranging system, such as a lidar system, that transmits light pulses 116 away from the AV 102. The transmitted light pulses 116 are incident on one or more objects, e.g., a pedestrian 118, a cyclist 120, and a remote vehicle 122, and reflect back toward the sensor system 108 as reflected light pulses 124. The controller 106 processes the reflected light pulses 124 to determine a distance of the object 118, 120, 122 relative to the AV 102. The sensor system 108 may include one or more emitters (not shown) for transmitting the light pulses 116, and an array of photodetectors (not shown) to receive the reflected light pulses 124.

The AV system 104 may communicate with a remote computing device 126 over a network 128. The remote computing device 126 may include one or more servers to process one or more processes of the technology described herein. The remote computing device 126 may also communicate with a database 130 over the network 128.

The test module 100 includes a housing 132 for mounting within a vehicle cabin. The housing 132 may be formed in a generally cylindrical shape to be received in a vehicle cup holder (not shown). The housing 132 supports a printed circuit board assembly (PCBA) 134 for connecting the series of buttons 114 with the AV system 104 to provide manual control of features of the AV system 104.

The series of buttons 114 include: an emergency stop button 136; a stop button 138, an engage button 140, and a ready button 142, according to one or more embodiments. The emergency stop button 136 functions like a conventional emergency stop button, and the AV system 104 controls a propulsion system to shut down and/or applies a braking system in response to activation of the emergency stop button 136. The stop button 138 initiates a gradual stop of the AV 102, as it pulls over to the side of the road. The engage button 140 activates the AV system 104. The ready button 142 turns on the AV system 104 and prepares it to engage.

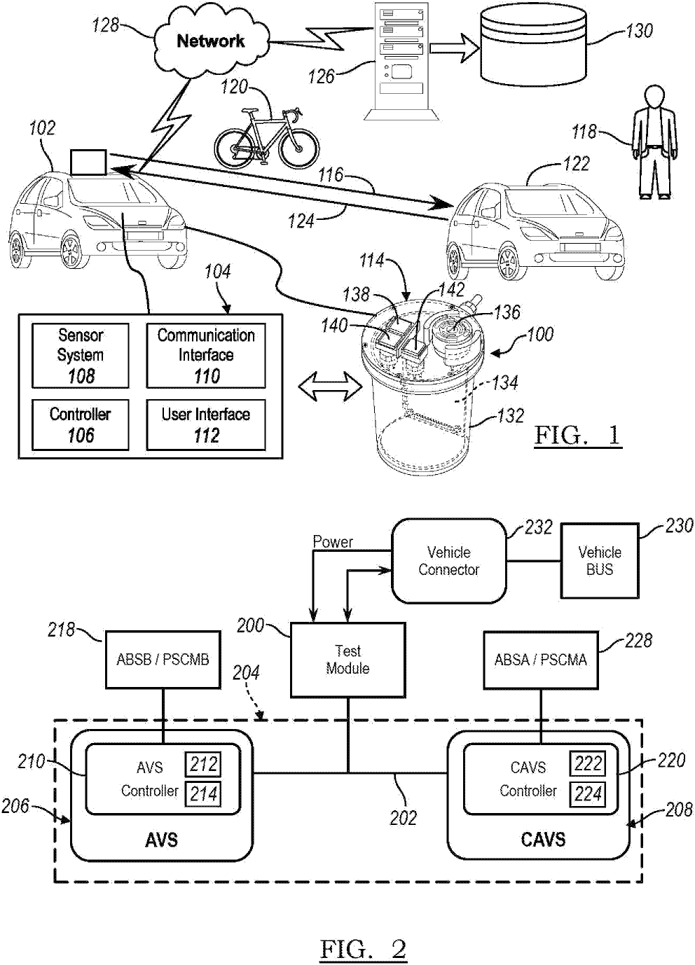

FIG. 2 is a schematic block diagram illustrating an example of a test module 200. Similar to the test module 100 of FIG. 1, the test module 200 communicates with an AV system 204. As shown in FIG. 2, the AV system 204 includes redundant subsystems, and the test module 200 may communicate with the AV system 204 over a private communication interface 202. The AV system 204 includes an AV subsystem (AVS) 206 and a complimentary AV subsystem (CAVS) 208 that each perform the same, or substantially the same, functionality. The AVS 206 and the CAVS 208 communicate with each other and with the test module 200 over the private communication interface 202, which may be a Controller Area Network Flexible Data-Rate (CAN-FD) two-wire interconnection. In other embodiments, the private communication interface 202 includes wireless communication.

The AVS 206 includes an AVS controller 210, including a processor 212 and memory 214. The AVS controller 210 communicates with a first vehicle controller 218 for controlling vehicle operation, e.g., anti-lock braking and power steering. The CAVS 208 includes architecture like that of the AVS 206. The CAVS 208 includes a CAVS controller 220, including a processor 222 and memory 224. The CAVS controller 220 communicates with a second vehicle controller 228 for controlling vehicle operation, e.g., anti-lock braking and power steering.

In one or more embodiments, the AVS controller 210 and/or the CAVS controller 222 of the AV system 204 communicate with the vehicle controllers 218, 228 to perform a minimum risk condition (MRC) response based on activation of one or more of the series of buttons 114. For example, in response to activation of the emergency stop button 136, the AV system 104 may communicate with the vehicle controllers 218, 228 to implement a Stop MRC Response to stop the AV 102 immediately by controlling a propulsion system to shut down and/or controlling a braking system to apply rapidly. Additionally, in response to activation of the stop button 138, the AV system 104 may communicate with the vehicle controllers 218, 228 to implement a Pullover MRC Response to pullover the AV 102, or look for a convenient location to pullover, by controlling a propulsion system to slow down, and/or controlling a braking system to apply gradually, while controlling a steering system to steer the AV 102 to a predetermined location e.g., a side of the road.

The test module 200 also communicates with other systems of the AV 102 over a vehicle communication interface 230, e.g., a high-speed CAN bus. For example, the test module 200 may connect to a vehicle connector 232, such as an On-Board Diagnostic (OBD) connector, to access the vehicle communication interface 230. The test module 200 may also receive electrical power from a vehicle power source through the vehicle connector 232. In other embodiments, the vehicle communication interface 230 includes wireless communication.

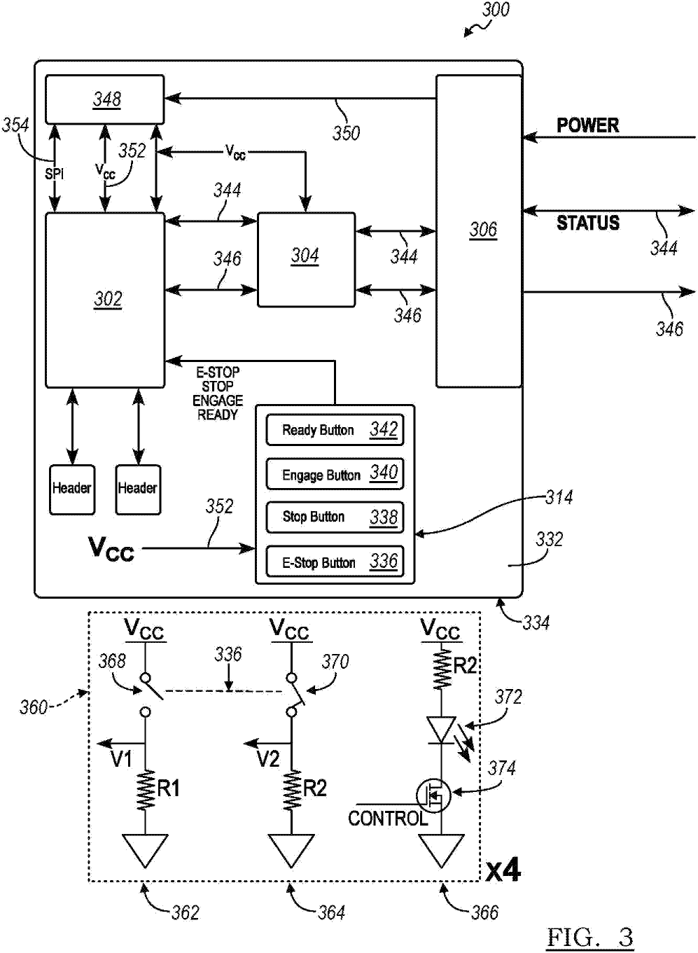

FIG. 3 is a schematic block diagram illustrating an example architecture for a test module 300. The test module 300 includes a controller 302, a transceiver 304, and a connector 306. The controller 302 is connected to a series of buttons 314 for receiving user requests. The controller 302, the transceiver 304, and the connector 306 may be mounted to a common circuit board 332 to collectively form a printed circuit board assembly (PCBA) 334.

Like the series of buttons 114 of FIG. 1, the series of buttons 314 provide user request signals to the controller 302 in response to user activation. The series of buttons 314 include: an emergency stop button 336; a stop button 338, an engage button 340, and a ready button 342. In one or more embodiments, the emergency stop button 336 provides an E-STOP request signal to the controller 302, the stop button 338 provides a STOP request signal to the controller 302, the engage button 340 provides an ENGAGE request signal to the controller 302, and the ready button 342 provides a READY request signal to the controller 302. The controller 302 converts the user request signals into data and provides the data to the AV 102 and/or the AV system 104, 204 to communicate with one or more vehicle controllers 218, 228 to control one or more vehicle systems, e.g., steering and braking systems.

The private communication interface 202 and the vehicle communication interface 230 may use different protocols. For example, in one embodiment, the private communication interface 202 is a CAN-FD protocol that operates at a bandwidth of two megabits per second (2 Mbps), and the vehicle communication interface 230 is a high-speed CAN bus that operates at a bandwidth of 500 kilobits per second (500 Kbps). Accordingly, the controller 302 converts user request signals that are destined for the AV system 104, 204 into a first format, e.g., CAN-FD protocol, and provides this data to the transceiver 304 on a first channel 344. The controller 302 also converts user request signals that are destined for the vehicle communication interface 230 into a second format, e.g., high-speed (HS) CAN protocol, and provides this data to the transceiver 304 on a second channel 346. The transceiver 304 provides both channels 344, 346 to the connector 306. The connector 306 is connected to the private communication interface 202 to provide data over the first channel 344. The connector 306 is also connected to the vehicle communication interface 230, e.g., through the vehicle connector 232, to provide data over the second channel 346.

In one embodiment, the test module 300 provides data corresponding to the E-STOP request signal and the STOP request signal to the private communication interface 202 of the AV system 104, 204 over the first channel 344; and provides data corresponding to the ENGAGE request signal and the READY request signal to the vehicle communication interface 230 of the AV 102 over the second channel 346. In other embodiments, the test module 300 provides all data to the AV system 104 and/or the AV 102.

The test module 300 includes a power management integrated circuit (PMIC) to regulate power supplied to different components of the PCBA 334. The PMIC 348 may receive electrical power from the AV 102 on an input line 350 at a first voltage, e.g., 12 VDC, convert the electrical power to a second voltage, or supply voltage (Vcc), e.g., 5 V and/or 3.3 V, and supply the second voltage to the controller 302 and/or the transceiver 304 on an output line 352. The PMIC 348 may also act as “watchdog” of the controller 302 and provide control and diagnostic reporting through a serial peripheral interface (SPI) 354, e.g., to initiate testing of the test module 300.

Each of the plurality of buttons 314 is connected to an apparatus 360 for testing the functionality of that button. The apparatus 360 may include three circuits: a first circuit 362, a second circuit 364, and a third circuit 366. The first circuit 362 includes a first switch 368 that is connected in series with a first resistor (R1) between a supply voltage (Vcc) and ground. The second circuit 364 includes a second switch 370 that is connected in series with a second resistor (R2) between Vcc and ground. The controller 302 monitors the voltage (V1) of the first circuit 362 and the voltage (V2) of the second circuit 364.

The first switch 368 and the second switch 370 are arranged in opposite configurations and connected to the same button, e.g., the emergency stop button 336. For example, in the illustrated embodiment, the first switch 368 is a normally open (NO) switch such that V1 is equal to zero volts when the corresponding button 314 is not activated; and the second switch 370 is a normally closed (NC) switch such that V2 is equal to Vcc when the corresponding button 314 is not activated. Then, when the corresponding button 314 is activated by the user, both switches 368, 370 change state, i.e., the first switch 368 closes and V1 increases to Vcc, and the second switch 370 opens and V2 decreases to zero.

The third circuit 366 includes a light emitting device 372, e.g., a light emitting diode (LED), that is connected in series with a third switch 374 between Vcc and ground. The controller 302 provides a control signal (CONTROL) to open and close the third switch 374 to facilitate current flow through the third circuit and turn on and turn off the light emitting device 372. The controller 302 may also control the light emitting device 372 to turn on and off by providing a control signal to the third switch 374.

Although the controller 302 is described as a single controller, it may contain multiple controllers, or may be embodied as software code within one or more other controllers. The controller 302 includes a processing unit, or processor, that may include any number of microprocessors, ASICs, ICs, memory (e.g., FLASH, ROM, RAM, EPROM and/or EEPROM) and software code to co-act with one another to perform a series of operations. Such hardware and/or software may be grouped together in assemblies to perform certain functions. Any one or more of the controllers or devices described herein include computer executable instructions that may be compiled or interpreted from computer programs created using a variety of programming languages and/or technologies. The controller 302 also includes memory, or non-transitory computer-readable storage medium, that is capable of executing instructions of a software program. The memory may be, but is not limited to, an electronic storage device, a magnetic storage device, an optical storage device, an electromagnetic storage device, a semi-conductor storage device, or any suitable combination thereof. In general, the processor receives instructions, for example from the memory, a computer-readable medium, or the like, and executes the instructions. The controller 302, also includes predetermined data, or “look up tables” that are stored within memory, according to one or more embodiments.

The test module 300 performs a self-test to evaluate its own status and provides this information to the AV 102, the AV system 104, 204, and a user within the vehicle cabin. The controller 302 provides a (STATUS) message to the AV system 104, 204 over the private communication interface 202 that indicates the current state of the test module 300 (e.g., ACTIVE, ERROR, or TEST) and the current state of each button 114, 314 (e.g., ON, OFF, or ERROR). The controller 302 may provide the STATUS message periodically, as a “heartbeat” message to the AV system 204. The test module 300 conveys the status information to a user within the AV 102 by controlling illumination of each light emitting device 372. For example, the test module 300 may control the light emitting devices 372 to blink to indicate an ERROR or TEST status.

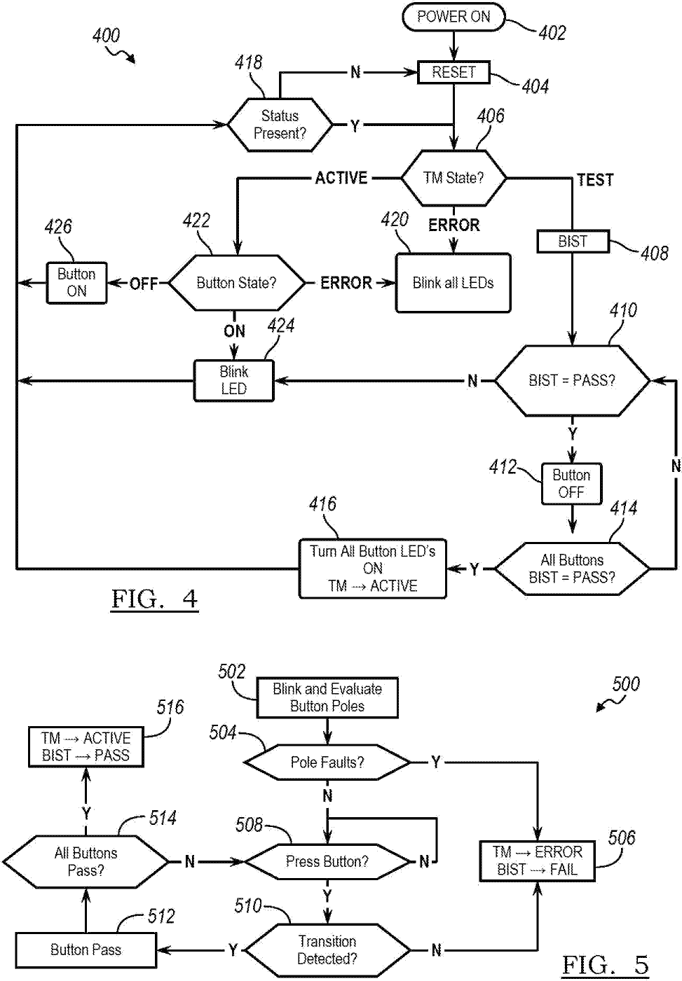

With reference to FIG. 4, a flow chart depicting a method for testing the test module 100, 200, 300 is illustrated in accordance with one or more embodiments and is generally referenced by numeral 400. The method 400 is implemented using software code that is executed by the controller 302 of the test module 300, according to one or more embodiments. While the flowchart is illustrated with a number of sequential steps, one or more steps may be omitted and/or executed in another manner without deviating from the scope and contemplation of the present disclosure.

At step 402, the AV 102 is turned on, and the test module 300 receives power. At step 404, the controller 302 resets a status or heartbeat message count, thereby changing the state of the test module 300 to TEST. At step 406, the controller 302 evaluates the state of the test module 300. The state of the test module 300 may be “ACTIVE,” indicating that it successfully completed its self-test; “ERROR,” indicating that it did not successfully compete the self-test; or “TEST,” indicating that it has not yet completed the self-test. If the controller 302 determines that the current state of the test module 300 is TEST at step 406, it controls the light emitting device 372 of each of the series of buttons 314 to blink to convey status information to the user, and proceeds to step 408 to perform a built-in self-test (BIST). FIG. 5 is a flow chart illustrating the BIST in detail and is generally referenced by numeral 500.

Referring to FIG. 5, at step 502, the controller 302 controls the light emitting device 372 of each of the series of buttons 314 to blink, and then evaluates the poles of each button 314 based on the voltage measurements V1 and V2. For example, the controller 302 may evaluate V1 for the normally open (NO) first switch 368 to confirm that V1 is equal to zero volts when the corresponding button 314 is not activated. If V1 is not equal to zero volts, that would indicate a pole fault, e.g., that a contact of the first switch 368 is stuck closed. The controller 302 may evaluate V2 for the normally closed (NC) second switch 370 to confirm that V2 is equal to Vcc when the corresponding button 314 is not activated. If V2 is not equal to Vcc, that would indicate a pole fault, e.g., that a contact of the second switch 370 is stuck open. At step 504, if the controller 302 identifies any pole faults, e.g., if V1 is not equal to zero, or V2 is not equal to Vcc, then the controller 302 proceeds to step 506 and sets the state of the test module 300 to ERROR and sets the state of the BIST to FAIL. If the controller 302 does not identify any pole faults, the controller 302 proceeds to step 508.

At step 508, the controller 302 waits for the user to activate, or press, one of the series of buttons 314. Once the user activates a button, the controller 302 proceeds to step 510 to determine if a transition is detected. The controller 302 evaluates the poles of the corresponding switches to confirm that both poles transition between different voltages, e.g., V1 transitions from zero volts to Vcc and V2 transitions from Vcc to zero volts. If the controller 302 does not detect a transition, it proceeds to step 506, and sets the state of the test module 300 to ERROR and sets the state of the BIST to FAIL. If a transition is detected, the controller 302 proceeds to step 512 and sets the button state to pass, then the controller 302 proceeds to step 514.

At step 514 the controller 302 evaluates the button states to determine if all buttons have passed. If not all of the buttons have passed, the controller 302 returns to step 514 and waits for the user to press another button of the series of buttons 314. In one or more embodiments, the controller 302 controls the light emitting device 372 of each of the series of buttons 314 to stop blinking when it is pressed at step 508, this informs the user of which buttons have been tested and which have not been tested. Once all of the buttons have been tested and pass the BIST, the controller 302 proceeds to step 516 and sets the control module state to ACTIVE and sets the BIST to PASS. After reaching step 516, or step 506, the controller 302 completes the BIST and proceeds to step 410 of FIG. 4.

Referring to FIG. 4, at step 410 the controller 302 evaluates the state of each of the series of buttons 314 individually. The controller 302 starts with a first button, e.g., the emergency stop button 336, and determines if the button passed the BIST. If the first button passed the BIST, i.e., if BIST = PASS, the controller 302 proceeds to step 412 and turns the corresponding light emitting device 372 off. At step 414 the controller 302 determines if all buttons passed the BIST, if not, the controller 302 returns to step 410 and evaluates the next button, e.g., the stop button 338. Once the controller 302 determines that all buttons passed the BIST at step 414, the controller 302 proceeds to step 416.

At step 416, the controller 302 turns on the light emitting device 372 for each of the series of the buttons 314 and sets the state of the test module 300 to ACTIVE. Then the controller 302 proceeds to step 418 to determine if the status message is present. If the status message is not present or has not been received within a predetermined period of time, the controller 302 returns to step 404 to reset the message count. If the status message is present, the controller 302 returns to step 406.

If, at step 406, the controller 302 determines that the current state of the test module 300 is ERROR, it proceeds to step 420 and controls the light emitting device 372 of each of the series of buttons 314 to blink. If, at step 406, the controller 302 determines that the current state of the test module 300 is ACTIVE, it proceeds to step 422 to evaluate the state of each button.

At step 422, if the controller 302 determines that a button state is equal to ERROR, the controller 302 proceeds to step 420 and controls the light emitting device 372 of each button 314 to blink. If, at step 422, the controller 302 determines that a button state is equal to ON, the controller 302 proceeds to step 424 and controls the corresponding light emitting device 372 to blink, and then returns to step 418. The controller 302 may control the corresponding light emitting device 372 to blink continuously or blink a predetermined number of times. For example, in one embodiment, the controller 302 controls the light emitting device 372 of the emergency stop button 336 to blink continuously, and controls the light emitting devices 372 of the stop button 338, the engage button 340, and the ready button 342, to blink 3-10 times. If, at step 422, the controller 302 determines that a button state is equal to OFF, the controller 302 proceeds to step 426 and controls the corresponding light emitting device 372 to turn on, and then returns to step 418.

The test module 300 includes a controller 302 and associated components that allow a vehicle operator monitoring the testing of an AV 102 to perform tasks such as engaging and disengaging autonomy functionalities of the AV 102, request regular stops, or perform emergency stop maneuvers. This test module 300 helps vehicle operators control the AV 102 in case the AV system 104 under test does not function properly by exposing a set of controls for manual control. The test module 300 is integrated deeply into the rest of the AV system 104, 204, becoming an intrinsic part of its communication. Executing generic maneuvers from user inputs could lead to undesirable vehicle conditions. Therefore, the test module 300 informs, with high reliability and availability, the AVS 206 of user requests, thereby interacting with a significant portion of the software stack, including embedded, perception, and planning algorithms.

Since the test module 300 interacts with software algorithms in the critical path of the AV 102, the test module 300 undergoes rigorous testing, but that way any interactions with the environment during the testing is handled appropriately by incorporating data known to the system. More specifically, at power on, the test module 300 performs a built-in self-test (BIST) to perform its own assessment of health, as described with reference to FIGS. 4 and 5. In normal operation, the test module 300 sends a high frequency “heartbeat” status message to the AV system 104, 204 to announce its current state of health and operational information (hardware, communication status, environmental data, etc.). When a user interaction is registered, i.e., a user presses one of the series of buttons 314, a corresponding user request signal is sent to both the AVS 206 and the CAVS 208 which are then able to cross-check that the request is being acted upon. Signals received by either the AVS 206 or the CAVS 208 can be interpreted into a wide spectrum of minimum risk condition (MRC) responses. Those MRC responses are then executed by the different responsible components in the systems (both hardware and software) ensuring appropriate responses to user requests.

Existing test equipment for requesting emergency stops are not tightly integrated with the system under test, meaning this equipment tends to perform generic actions that could potentially lead to unexpected vehicle conditions, e.g., by opening a power relay to remove propulsive power to a platform, or disconnecting communication lines. Those methods, while useful in industrial environment, do not scale gracefully to autonomous vehicles operating on public roads. The test module 300 provides benefits over such existing test equipment by being tightly integrated within the AV system 104, 204 leveraging different components of the software stack for reliable operation even in the event of unforeseen test conditions.

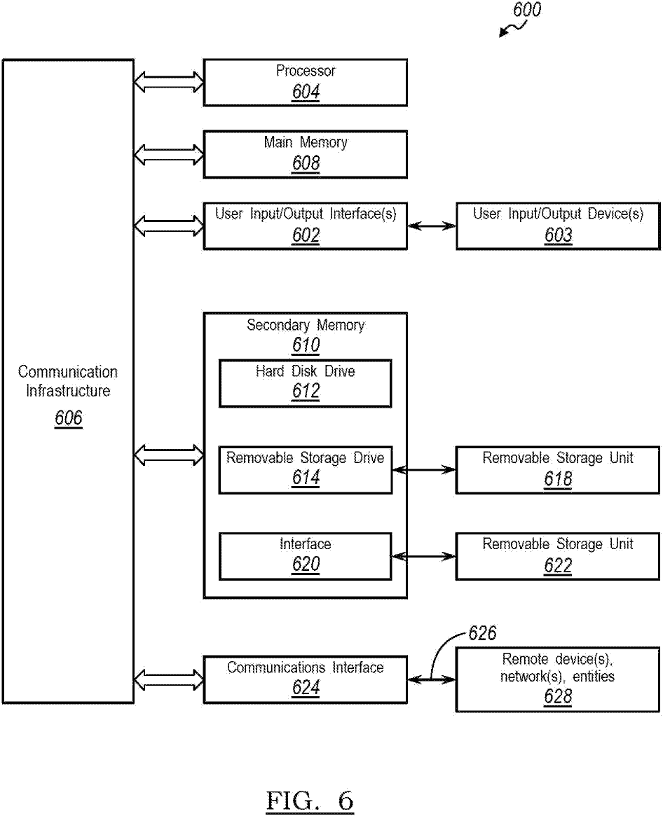

The system and method for testing a test module of an AV system may be implemented using one or more controllers, such as computer system 600 shown in FIG. 6. The computer system 600 may be any computer capable of performing the functions described herein. The computer system 600 also includes user input/output interface(s) 602 and user input/output device(s) 603, such as buttons, monitors, keyboards, pointing devices, etc.

The computer system 600 includes one or more processors (also called central processing units, or CPUs), such as a processor 604. The processor 604 is connected to a communication infrastructure or bus 606. The processor 604 may be a graphics processing unit (GPU), e.g., a specialized electronic circuit designed to process mathematically intensive applications, with a parallel structure for parallel processing large blocks of data, such as mathematically intensive data common to computer graphics applications, images, videos, etc.

The computer system 600 also includes a main memory 608, such as random-access memory (RAM), that includes one or more levels of cache and stored control logic (i.e., computer software) and/or data. The computer system 600 may also include one or more secondary storage devices or secondary memory 610, e.g., a hard disk drive 612; and/or a removable storage device 614 that may interact with a removable storage unit 618. The removable storage device 614 and the removable storage unit 618 may be a floppy disk drive, a magnetic tape drive, a compact disk drive, an optical storage device, tape backup device, and/or any other storage device/drive.

The secondary memory 610 may include other means, instrumentalities or other approaches for allowing computer programs and/or other instructions and/or data to be accessed by computer system 600, e.g., an interface 620 and a removable storage unit 622, e.g., a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

The computer system 600 may further include a network or communication interface 624 to communicate and interact with any combination of remote devices, remote networks, remote entities, etc. (individually and collectively referenced by reference number 628). For example, the communication interface 624 may allow the computer system 600 to communicate with remote devices 628 over a communication path 626, which may be wired and/or wireless, and which may include any combination of LANs, WANs, the Internet, etc. The control logic and/or data may be transmitted to and from computer system 600 via communication path 626.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, the computer system 600, the main memory 608, the secondary memory 610, and the removable storage units 618 and 622, as well as tangible articles of manufacture embodying any combination of the foregoing. Such control logic, when executed by one or more data processing devices (such as the computer system 600), causes such data processing devices to operate as described herein.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” (or “AV”) is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle’s autonomous system and may take control of the vehicle. Notably, the test module 300 is being described herein in the context of an autonomous vehicle (AV). However, the test module 300 is not limited to autonomous vehicle applications; it may be used in other applications such as robotic applications, radar system applications, metric applications, and/or system performance applications.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the detailed description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other. The breadth and scope of this disclosure should not be limited by any of the above-described exemplary embodiments but should be defined only in accordance with the following claims and their equivalents.

While exemplary embodiments are described above, it is not intended that these embodiments describe all possible forms. Rather, the words used in the specification are words of description rather than limitation, and it is understood that various changes may be made without departing from the spirit and scope of the disclosure. Additionally, the features of various implementing embodiments may be combined to form further embodiments.

What is claimed is:

1. A test module comprising:
a housing for mounting within a cabin of an autonomous vehicle (AV);
at least two user input devices supported by the housing;
a controller disposed within the housing and programmed to:
generate a first request to control an AV system of the AV based on manual activation of one of the at least two user input devices, and
generate a second request to control the AV system based on manual activation of the other of the at least two user input devices; and
at least one transceiver to provide the first request to the AV on a first communication interface and to provide the second request to the AV system on a second communication interface.

2. The test module of claim 1, wherein the at least two user input devices further comprise a first user input device and a second user input device, wherein the controller is further programmed to:
generate at least one of a ready request to turn on the AV system, and an engage request to activate the AV system, in response to manual activation of the first user input device; and
generate at least one of an emergency stop request to disable a propulsion system, and a stop request to activate at least one of a braking system and a steering system, in response to manual activation of the second user input device.

3. The test module of claim 1 further comprising at least one light emitting device mounted proximate to each user input device, wherein the controller is further programmed to control the at least one light emitting device to blink in response to detecting a fault associated with the proximate user input device.

4. The test module of claim 1, wherein the first communication interface further comprises a controllable area network (CAN) bus and wherein the second communication interface further comprises a CAN Flexible Data-Rate (CAN-FD) two-wire interconnection.

5. The test module of claim 1, wherein the at least two user input devices further comprise a first user input device and a second user input device, the test module further comprising:
a first light emitting device mounted proximate to the first user input device;
a first switch coupled to the first user input device; and
wherein the controller is further programmed to:
monitor a first voltage across the first switch,
control the first light emitting device to blink in response to the first voltage indicating a first switch fault.

6. The test module of claim 5, wherein the controller is further programmed to:
initiate a self-test of the first user input device in response to receiving power;
control the first light emitting device to blink in response to initiation of the self-test; and
control the first light emitting device to turn off in response to successful completion of the self-test.

7. The test module of claim 5 further comprising a first apparatus for monitoring the first user input device, the first apparatus comprising:
a first circuit to connect a supply voltage to ground, the first circuit comprising the first switch coupled to the first user input device to enable current flow along the first circuit in response to manual activation of the first user input device; and
a second circuit to connect the supply voltage to ground, the second circuit comprising a second switch coupled to the first user input device to disable current flow along the second circuit in response to manual activation of the first user input device.

8. The test module of claim 7, further comprising a third circuit to connect the supply voltage to ground through the first light emitting device, the third circuit comprising a third switch connected in series with the first light emitting device to enable current flow through the first light emitting device to illuminate the first user input device.

9. The test module of claim 7, wherein the controller is further programmed to:
monitor a second voltage across the second switch; and
control the first light emitting device to blink in response to the first voltage being equal to the second voltage, indicating a fault associated with at least one of the first switch and the second switch.

10. The test module of claim 9, wherein the controller is further programmed control the first light emitting device to blink in response to the first voltage not changing and the second voltage changing, wherein the second voltage changing is indicative of manual activation of the first user input device.

11. A method for testing a test module for an autonomous vehicle (AV) system comprising:
generating a first request to control the AV system based on manual activation of a first user input device of the test module;
generating a second request to control the AV system based on manual activation of a second user input device of the test module;
transmitting the first request to an AV on a first communication interface; and
transmitting the second request to the AV system on a second communication interface.

12. The method of claim 11 further comprising:
monitoring a first voltage across a first switch coupled to the first user input device; and
controlling a first light emitting device mounted proximate to the first user input device to blink in response to the first voltage indicating a first switch fault.

13. The method of claim 12 further comprising:
initiating a self-test of the first user input device, including monitoring the first voltage, in response to receiving power;
controlling the first light emitting device to blink in response to initiation of the self-test; and
controlling the first light emitting device to turn off in response to successful completion of the self-test.

14. The method of claim 12 further comprising:
monitoring the first voltage across the first switch coupled to the first user input device, wherein the first switch is adapted to enable current flow between a supply voltage source and ground in response to manual activation of the first user input device;
monitoring a second voltage across a second switch coupled to the first user input device, wherein the second switch is adapted to disable current flow between the supply voltage source and ground in response to manual activation of the first user input device; and
controlling the first light emitting device associated with the first user input device to blink in response to the first voltage being equal to the second voltage.

15. The method of claim 14 further comprising controlling the first light emitting device to blink in response to the first voltage changing and the second voltage not changing, wherein the first voltage changing is indicative of manual activation of the first user input device.

16. The method of claim 11 further comprising:
controlling a first light emitting device associated with the first user input device to turn off in response to successful completion of a self-test of the first user input device; and
controlling the first light emitting device associated with the first user input device and a second light emitting device associated with the second user input device to turn on in response to successful completion of all user input device self-tests.

17. The method of claim 11 further comprising:
generating the first request at a first bandwidth; and
generating the second request at a second bandwidth different from the first bandwidth.

18. A non-transitory computer-readable medium having instructions stored thereon that, when executed by at least one computing device, cause the at least one computing device to perform operations comprising:
generating a first request to control an autonomous vehicle (AV) system based on manual activation of a first user input device;
generating a second request to control the AV system based on manual activation of a second user input device;
transmitting the first request to an AV on a first communication interface;
transmitting the second request to the AV system on a second communication interface;
monitoring a first voltage across a first switch coupled to the first user input device; and
controlling a first light emitting device mounted proximate to the first user input device to blink in response to the first voltage indicating a first switch fault.

19. The non-transitory computer-readable medium of claim 18, wherein the operations further comprise:
controlling the first light emitting device to blink in response to the first voltage not changing in response to manual activation of the first user input device.

20. The non-transitory computer-readable medium of claim 18, wherein the operations further comprise:
monitoring the first voltage across the first switch coupled to the first user input device, wherein the first switch is adapted to enable current flow between a supply voltage source and ground in response to manual activation of the first user input device;
monitoring a second voltage across a second switch coupled to the first user input device, wherein the second switch is adapted to disable current flow between the supply voltage source and ground in response to manual activation of the first user input device; and
controlling the first light emitting device associated with the first user input device to blink in response to the first voltage being equal to the second voltage.
